(19) United States
(12) Patent Application Publication
(10) Pub. No.: US 2026/0070157 A1
(43) Pub. Date: Mar. 12, 2026

(54) GLASS SUBSTRATE PROCESSING METHOD

(71) Applicant: JWMT Inc., Ansan-si (KR)

(72) Inventor: Sung Soo PARK, Yongin-si (KR)

(73) Assignee: JWMT Inc., Ansan-si, Gyeonggi-do (KR)

(21) Appl. No.: 19/265,041

(22) Filed: Jul. 10, 2025

(30) Foreign Application Priority Data
Sep. 11, 2024 (KR) 10-2024-0123830

(51) Int. Cl. B23K 26/384; B23K 26/06; B23K 26/70; B23K 103/00

(52) U.S. Cl. CPC B23K 26/384; B23K 26/0626; B23K 26/70; B23K 2103/54

(57) ABSTRACT

A glass substrate processing method includes: a first deformed portion formation step; a second deformed portion formation step; and a via-hole formation step, wherein, in the first deformed portion formation step, a first deformed portion is formed in a glass substrate by moving a first laser beam along a first imaginary line having a first radius, in the second deformed portion formation step, a second deformed portion is formed in the glass substrate by moving a second laser beam along a second imaginary line having a second radius larger than the first radius, and in the via-hole formation step, a via-hole having an enlarged inner diameter portion at both ends thereof adjoining upper and lower surfaces of the glass substrate is formed by dipping the glass substrate with the first deformed portion and the second deformed portion formed therein in an etching solution.

### CROSS-REFERENCE TO RELATED APPLICATION

This application claims the benefit of Korean Patent Application Nos. 10-2024-0123830 filed on Sep. 11, 2024 in the Korean Intellectual Property Office, the entire disclosure of which is incorporated herein by reference for all purposes.

### BACKGROUND

The present invention relates to a glass substrate processing method and, more particularly, to a method of forming via-holes through a glass substrate using laser modification and etching processes.

Glass possesses good electrical properties, dimensional stability, a low coefficient of thermal expansion (CTE), high thermal stability, and good surface quality. Furthermore, glass can be precisely and finely processed to create via-holes therethrough and thus is suitable for use as a substrate for semiconductor packaging, a fixture plate for precision jigs and inspection equipment, and the like.

FIG. 1 is an exemplary view of an inspection apparatus using a glass substrate with via-holes.

The inspection apparatus basically includes: a probe unit 3 disposed at one side of a glass substrate 1 and having probe pins 4 corresponding to respective via-holes 2; and a wafer substrate 5 disposed at the other side of the glass substrate 1 and formed with bumps 6 corresponding to respective probe pins 4.

That is, the probe unit 3 is activated to allow the probe pins 4 to be inserted into the respective via-holes 2 and the performance of the wafer substrate 5 is inspected based on current-carrying data generated from contact between the inserted probe pins 4 and the bumps 6. Here, the via-holes 2 of the glass substrate 1 act as guides for positioning the probe pins 4 during insertion.

The inspection process described above is typically repeated hundreds of thousands of times. This repetitive action causes severe friction between the probe pin 4 passing through the via-hole 2 and a sharp edge E of the via-hole 2, leading to problems such as warpage of the probe pin 4 or damage to an insulating coating on the surface thereof. This shortens the lifespan of the probe unit 3, necessitating frequent replacement thereof.

### SUMMARY

Embodiments of the present invention are conceived to solve such problems in the art and it is an aspect of the present invention to provide a glass substrate processing method that can prevent damage to probe pins used in product inspection by improving a process of forming via-holes through a glass substrate, rather than directly improving the structure of an inspection apparatus.

It will be understood that aspects of the present invention are not limited to those described above. The above and other aspects of the present invention will become apparent to those skilled in the art from the detailed description of the following embodiments in conjunction with the accompanying drawings.

In accordance with one aspect of the present invention, a glass substrate processing method includes: a first deformed portion formation step in which a first deformed portion is formed in a glass substrate by moving a first laser beam along a first imaginary line having a first radius; a second deformed portion formation step in which a second deformed portion is formed in the glass substrate by moving a second laser beam along a second imaginary line having a second radius larger than the first radius; and a via-hole formation step in which a via-hole having an enlarged inner diameter portion at both ends thereof adjoining upper and lower surfaces of the glass substrate is formed by dipping the glass substrate with the first deformed portion and the second deformed portion formed therein in an etching solution such that the first deformed portion and the second deformed portion are etched, wherein a region of the glass substrate in which the first deformed portion is etched away has a first etch selectivity and a region of the glass substrate in which the second deformed portion is etched away has a second etch selectivity lower than the first etch selectivity.

In the first deformed portion formation step, the first laser beam may be applied to the glass substrate with a first intensity and, in the second deformed portion formation step, the second laser beam may be applied to the glass substrate with a second intensity lower than the first intensity.

In the first deformed portion formation step, the first laser beam may be applied to the glass substrate such that the first deformed portion is formed throughout a thickness of the glass substrate and, in the second deformed portion formation step, the second laser beam may be applied to the glass substrate such that the second deformed portion is formed in a region of an upper portion of the glass substrate and in a region of a lower portion of the glass substrate.

In the first deformed portion formation step, the first laser beam may be applied to the glass substrate in the form of a first number of bursts and, in the second deformed portion formation step, the second laser beam may be applied to the glass substrate in the form of a second number of bursts fewer than the first number of bursts.

In the via-hole formation step, the via-hole may be formed by removing the first deformed portion, the second deformed portion, and a region of the glass substrate located inside the first imaginary line.

The second radius of the second imaginary line may be less than or equal to a target radius of the via-hole.

The enlarged inner diameter portion may have a horizontal length, wherein the horizontal length of the enlarged inner diameter portion may increase with increasing difference between the second radius of the second imaginary line and the first radius of the first imaginary line.

The enlarged inner diameter portion may have an inclination angle, the second laser beam may be applied to the glass substrate with a second intensity, and the inclination angle of the enlarged inner diameter portion may decrease with decreasing second intensity of the second laser beam.

In accordance with another aspect of the present invention, a glass substrate processing method includes: a first deformed portion formation step in which a first deformed portion is formed in a glass substrate by moving a first laser beam along a first imaginary line having a first radius; a second deformed portion formation step in which a second deformed portion is formed in the glass substrate by moving a second laser beam along a second imaginary line having a second radius larger than the first radius; and a via-hole formation step in which a via-hole having an enlarged inner diameter portion at both ends thereof adjoining upper and lower surfaces of the glass substrate is formed by dipping the glass substrate with the first deformed portion and the second deformed portion formed therein in an etching solution such that the first deformed portion and the second deformed portion are etched, wherein the first laser beam is applied perpendicularly to upper and lower surfaces of the glass substrate and the second laser beam is applied obliquely to the upper and lower surfaces of the glass substrate.

In the via-hole formation step, the via-hole may be formed by removing the first deformed portion, the second deformed portion, and a region of the glass substrate located inside the first imaginary line.

Embodiments of the present invention provide a glass substrate processing method in which a via-hole with an enlarged inner diameter portion at both ends thereof adjoining upper and lower surfaces of a glass substrate is formed by forming a first deformed portion and a second deformed portion using a first laser beam and a second laser beam, respectively, followed by an etching process, thereby preventing damage to probe pins that repeatedly pass through the via-hole during current carrying performance tests and thus significantly improving durability of a probe unit.

It will be understood that advantageous effects of the present invention are not limited to those described above and include any advantageous effects conceivable from the features disclosed in the detailed description of the present invention or the appended claims.

### BRIEF DESCRIPTION OF THE DRAWINGS

The above and other aspects, features, and advantages of the present invention will become apparent from the detailed description of the following embodiments in conjunction with the accompanying drawings:

FIG. 1 is an exemplary view of an inspection apparatus using a glass substrate with via-holes;

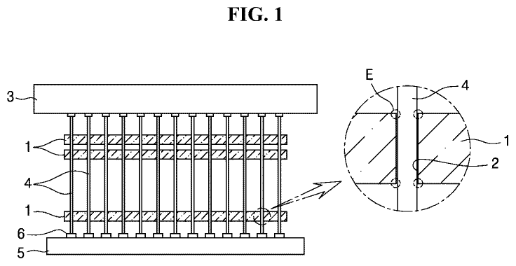

FIG. 2 is a block flow diagram of a glass substrate processing method according to one embodiment of the present invention;

FIG. 3 is an exemplary view of a first deformed portion formation step and a second deformed portion formation step according to one embodiment of the present invention;

FIG. 4 is an exemplary view of a via-hole formation step according to one embodiment of the present invention;

FIG. 5 is an exemplary view of a via-hole of a glass substrate manufactured by the glass substrate processing method according to one embodiment of the present invention;

FIG. 6 is a view illustrating a relationship between a second radius of a second imaginary line and a target via-hole radius;

FIG. 7 is a view illustrating adjustment of a horizontal length of an enlarged inner diameter portion;

FIG. 8 is a view illustrating adjustment of an inclination angle of the enlarged inner diameter portion;

FIG. 9 is a view of a first modification of the first deformed portion formation step and the second deformed portion formation step;

FIG. 10 is a view of a second modification of the first deformed portion formation step and the second deformed portion formation step; and

FIG. 11 is an exemplary view of a first deformed portion formation step and a second deformed portion formation step according to another embodiment of the present invention.

### DETAILED DESCRIPTION

Hereinafter, exemplary embodiments of the present invention will be described in detail with reference to the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

Throughout the specification, when an element or layer is referred to as being “on”, “connected to”, or “coupled to” another element or layer, it may be directly on, connected to, or coupled to the other element or layer or intervening elements or layers may be present. In addition, unless stated otherwise, the term “includes” should be interpreted as not excluding the presence of other components than those listed herein.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises”, “comprising”, “includes”, and/or “including” when used in this specification, specify the presence of stated features, integers, steps, operations, elements, components, and/or groups thereof, but do not preclude the presence or addition of one or more other features, integers, steps, operations, elements, components, and/or groups thereof.

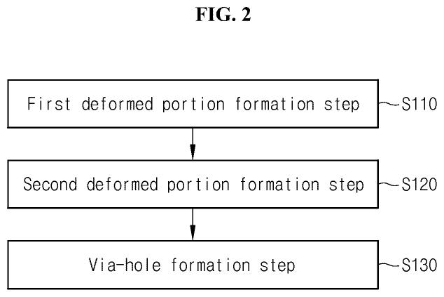

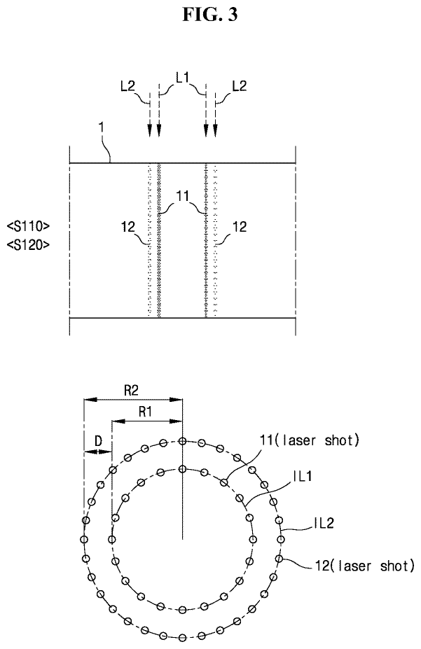

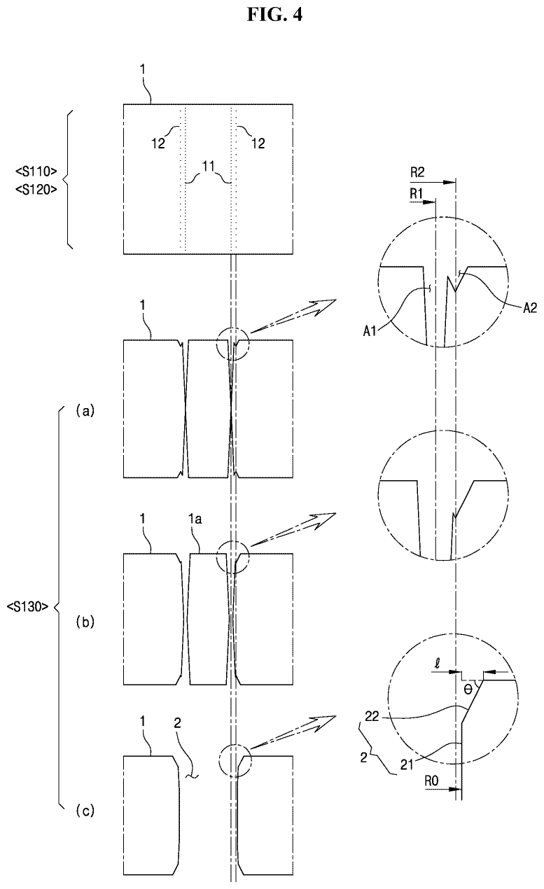

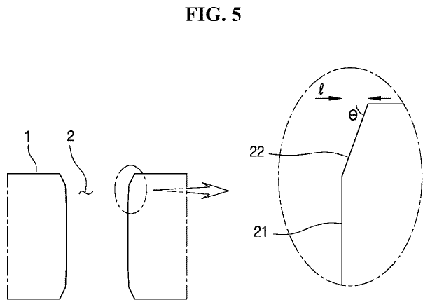

FIG. 2 is a block flow diagram of a glass substrate processing method according to one embodiment of the present invention, FIG. 3 is an exemplary view of a first deformed portion formation step and a second deformed portion formation step according to one embodiment of the present invention, FIG. 4 is an exemplary view of a via-hole formation step according to one embodiment of the present invention, and FIG. 5 is an exemplary view of a via-hole of a glass substrate manufactured by the glass substrate processing method according to one embodiment of the present invention.

The glass substrate processing method according to one embodiment of the present invention relates to a method of forming via-holes through a glass substrate using laser modification and etching processes and may include a first deformed portion formation step S110, a second deformed portion formation step S120, and a via-hole formation step S130.

The first deformed portion formation step S110 is a step in which a first deformed portion 11 is formed in a glass substrate 1 by applying a first laser beam L1 to the glass substrate 1. That is, in the first deformed portion formation step S110, the first deformed portion 11 may be formed in the glass substrate 1 by moving the first laser beam L1 along a first imaginary line IL1 having a first radius R1.

The first deformed portion 11 is a region that undergoes physical/chemical structural deformation through a non-linear photoionization process induced by the first laser beam L1. The first deformed portion 11 may be etched away by dipping the glass substrate 1 in an etching solution. With the glass substrate 1 dipped in the etching solution, the first deformed portion 11 may be etched 20 to 300 times faster than a non-deformed portion to which the first laser beam L1 is not applied.

Referring to FIG. 3, in the first deformed portion formation step S110, the first laser beam L1 may be applied along the first imaginary line IL1 with relatively wide spacing between shots, or may be applied along the first imaginary line IL1 with relatively tight spacing between shots. Accordingly, the first deformed portion 11 may be formed in the shape of discontinuous stitches along the first imaginary line IL1, or may be formed continuously along the first imaginary line IL1.

In addition, in the first deformed portion formation step S110, the first deformed portion 11 may be formed using a Bessel beam as the first laser beam L1. Upon application of the Bessel beam as the first laser beam L1, the position of the Bessel beam may be set to correspond to a length (depth) of the first deformed portion 11. The Bessel beam may be shaped using an optical system, such as a convex axicon lens, and may have a longitudinal component having uniform energy intensity over a desired distance in a thickness direction of the glass substrate 1. In addition, a length of the Bessel beam may be changed by varying an angle of an exit surface of the convex axicon lens.

The second deformed portion formation step S120 is a step in which a second deformed portion 12 is formed in the glass substrate 1 by applying a second laser beam L2 to the glass substrate 1. That is, in the second deformed portion formation step S120, the second deformed portion 12 may be formed in the glass substrate 1 by moving the second laser beam L2 along a second imaginary line IL2 having a second radius R2. Here, the second radius R2 may be greater than the first radius R1.

Similarly to the first deformed portion 11, the second deformed portion 12 is a region that undergoes physical/chemical structural deformation through a nonlinear photoionization process induced by the second laser beam L2. The second deformed portion 12 may be etched away by dipping the glass substrate 1 in an etching solution. With the glass substrate 1 dipped in the etching solution, the second deformed portion 12 may be etched 20 to 300 times faster than a non-deformed portion to which the second laser beam L2 is not applied.

Referring to FIG. 3, in the second deformed portion formation step S110, the second laser beam L2 may be applied along the second imaginary line IL2 with relatively wide spacing between shots, or may be applied along the second imaginary line IL2 with relatively tight spacing between shots. Accordingly, the second deformed portion 11 may be formed in the shape of discontinuous stitches along the second imaginary line IL2, or may be formed continuously along the second imaginary line IL2.

In addition, in the second deformed portion formation step S110, the second deformed portion 12 may be formed using a Bessel beam as the second laser beam L2. Upon application of the Bessel beam as the second laser beam L2, the position of the Bessel beam may be set to correspond to a length (depth) of the second deformed portion 12. The Bessel beam may be shaped using an optical system, such as a convex axicon lens, and may have a longitudinal component having uniform energy intensity over a desired distance in the thickness direction of the glass substrate 1. In addition, a length of the Bessel beam may be changed by varying an angle of an exit surface of the convex axicon lens.

The first deformed portion formation step S110 and the second deformed portion formation step S120 may be performed simultaneously. Alternatively, the first deformed portion formation step S110 may be performed first, followed by the second deformed portion formation step S120, or the second deformed portion formation step S120 may be performed first, followed by the first deformed portion formation step S110.

The via-hole formation step S130 may be a step in which a via-hole 2 is formed through the glass substrate 1 by dipping the glass substrate 1 with the first deformed portion 11 and the second deformed portion 12 formed therein in an etching solution such that the first deformed portion 11 and the second deformed portion 12 are etched.

The via-hole 2 formed through the via-hole formation step S130 may have an enlarged inner diameter portion 22 at both ends thereof adjoining upper and lower surfaces of the glass substrate 1.

Referring to FIG. 4, which sequentially illustrates the etching process over time with the glass substrate dipped in the etching solution, a region A1 of the glass substrate 1 where the first deformed portion 11 is etched away has a first etch selectivity, whereas a region A2 of the glass substrate 1 where the second deformed portion 12 is etched away has a second etch selectivity lower than the first etch selectivity.

Herein, “etch selectivity” may be defined as the ratio of an etch rate of a corresponding deformed portion to an etch rate of non-deformed glass. Given that a deformed portion with a relatively high degree of deformation is etched faster than a deformed portion with a relatively low degree of deformation, the etch selectivity of the deformed portion with a relatively high degree of deformation may be higher than that of the deformed portion with a relatively low degree of deformation.

In this embodiment, to ensure that the region A1 of the glass substrate 1 where the first deformed portion 11 is etched way has a first etch selectivity and the region A2 of the glass substrate 1 where the second deformed portion 12 is etched away has a second etch selectivity lower than the first etch selectivity, the first laser beam L1 is applied to the glass substrate 1 with a first intensity in the first deformed portion formation step S110 and the second laser beam L2 is applied to the glass substrate 1 with a second intensity in the second deformed portion formation step S120. Here, the second intensity of the second laser beam L2 may be less than the first intensity of the first laser beam L1.

The first deformed portion 11 and the second deformed portion 12, which are formed by laser beams with different energy intensities, respectively, may exhibit differences in physical/chemical structural deformation.

The first deformed portion 11 formed by the first laser beam L1 with a relatively high energy intensity may be formed to a relatively large extent in the thickness direction of the glass substrate 1 and may undergo a relatively high degree of physical/chemical deformation. Conversely, the second deformed portion 12 formed by the second laser beam L2 with a relatively low energy intensity may be formed to a relatively small extent in the thickness direction of the glass substrate 1 and may undergo a relatively low degree of physical/chemical deformation.

Since the first deformed portion 11 formed by the first laser beam L1 with the first intensity undergoes a higher degree of deformation than the second deformed portion 12 formed by the second laser beam L2 with the second intensity, the first deformed portion 11 can be etched at a higher rate than the second deformed portion 12 during the etching process, whereby the first etch selectivity of the first deformed portion 11 can be higher than the second etch selectivity of the second deformed portion 12.

As shown in FIG. 4, as the first deformed portion 11 is removed at a higher rate than the second deformed portion 12 in the thickness direction of the glass substrate 1, a region 1a of the glass substrate located inside the first imaginary line IL1 can be removed.

As described above, the first deformed portion 11, the second deformed portion 12, and the region 1a located inside the first imaginary line IL1 are removed through the etching process, resulting in formation of a via-hole 2 having an enlarged inner diameter portion 22 at both ends thereof adjoining the upper and lower surfaces of the glass substrate 1.

Referring to FIG. 5, the via-hole 2 thus formed may have a uniform inner diameter portion 21 having a uniform radius R0 and a pair of enlarged inner diameter portions 22 connected to opposite ends of the uniform inner diameter portion 21 and gradually increased in inner diameter towards the upper and lower surfaces of the glass substrate 1.

The radius of the uniform inner diameter portion 21 may correspond to a target via-hole radius R0. Here, the target via-hole radius R0 is defined as a final desired radius for determining acceptability of the via-hole 2.

The enlarged inner diameter portion 22 may have an inclination angle θ and a horizontal length l. Here, the inclination angle θ is defined as an angle that the enlarged inner diameter portion 22 forms with the upper and lower surfaces of the glass substrate 1, and the horizontal length l is defined as a length of an imaginary side parallel to the upper and lower surfaces of the glass substrate 1.

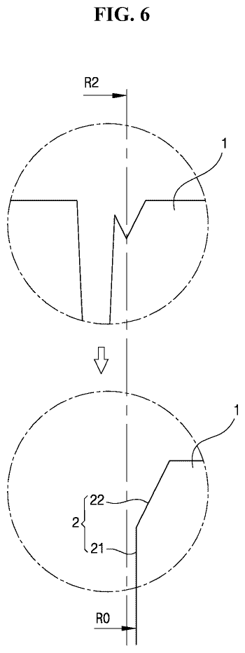

FIG. 6 is a view illustrating a relationship between the second radius of the second imaginary line and the target via-hole radius.

Referring to FIG. 6, the second radius R2 of the second imaginary line is preferably less than or equal to the target via-hole radius R0.

During the etching process, some regions of the glass substrate 1 are etched away in the thickness direction of the glass substrate 1, while some regions of the glass substrate 1 are etched away in a horizontal direction of the glass substrate 1. Of course, since the glass substrate 1 is deformed in the thickness direction of the glass substrate 1 before the etching process, the etch rate of the glass substrate 1 in the horizontal direction thereof is much lower than the etch rate of the glass substrate 1 in the thickness direction thereof.

Since the first deformed portion 11 and the second deformed portion 12 are etched not only in the thickness direction of the glass substrate 1 but also in the horizontal direction of the glass substrate 1, it is desirable that the second radius R2 of the second imaginary line be less than or equal to the target via-hole radius R0 to ensure that a final via-hole has the target radius R0).

If the second radius R2 of the second imaginary line exceeds the target via-hole radius R0, the resulting via-hole 2 can have a radius greater than the target via-hole radius R0 due to etching in the horizontal direction of the glass substrate 1. The via-hole 2 thus formed may be deemed defective since the radius of the via-hole 2 exceeds an allowable tolerance range of the target via-hole radius R0.

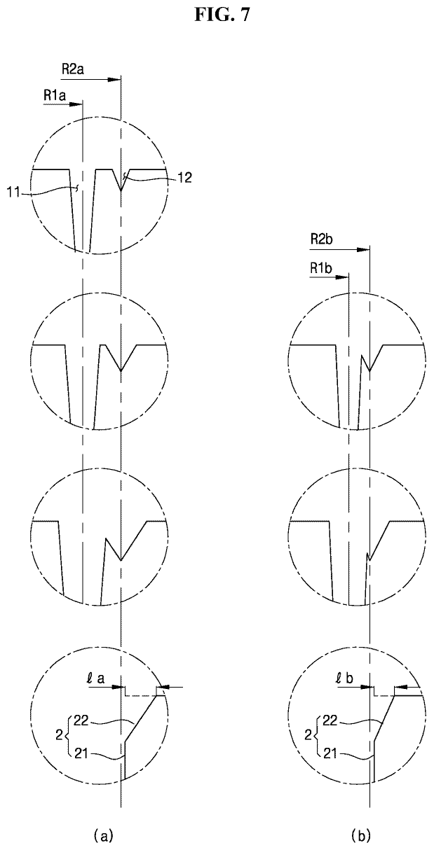

FIG. 7 is a view illustrating adjustment of the horizontal length of the enlarged inner diameter portion.

In this embodiment, the horizontal length l of the enlarged inner diameter portion 22 may increase with increasing difference between the second radius R2 of the second imaginary line and the first radius R1 of the first imaginary line.

FIG. 7 compares a case in which there is a relatively large difference between a second radius R2a of the second imaginary line and a first radius R1a of the first imaginary line (FIG. 7(a)) with a case in which there is a relatively small difference between a second radius R2b of the second imaginary line and a first radius R1b of the first imaginary line (FIG. 7(b)).

Referring to FIG. 7(a), when there is a relatively large difference between the second radius R2a of the second imaginary line and the first radius R1a of the first imaginary line, a distance between the first deformed portion 11 and the second deformed portion 12 is relatively large.

Since it takes a relatively long time for an etched-away region of the first deformed portion 11 to meet an etched-away region of the second deformed portion 12, the extent to which the second deformed portion 12 is etched in the horizontal direction of the glass substrate 1 increases, resulting in a relatively large horizontal length la of the enlarged inner diameter portion.

Referring to FIG. 7(b), when there is a relatively small difference between the second radius R2b of the second imaginary line and the first radius R1b of the first imaginary line, a distance between the first deformed portion 11 and the second deformed portion 12 is relatively small.

Since it takes a relatively short time for an etched-away region of the first deformed portion 11 to meet an etched-away region of the second deformed portion 12, the extent to which the second deformed portion 12 is etched in the horizontal direction of the glass substrate 1 decreases, resulting in a relatively small horizontal length lb of the enlarged inner diameter portion.

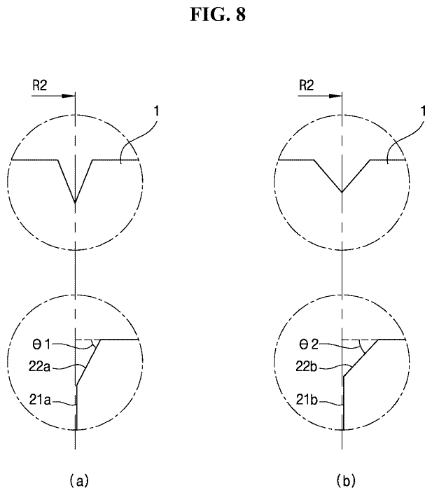

FIG. 8 is a view illustrating adjustment of the inclination angle of the enlarged inner diameter portion.

In the present invention, the inclination angle θ of the enlarged inner diameter portion 22 may decrease with decreasing second intensity of the second laser beam L2.

FIG. 8 compares a case where the second intensity of the second laser beam L2 is relatively high (FIG. 8(a)) with a case where the second intensity of the second laser beam L2 is relatively low (FIG. 8(b)).

Referring to FIG. 8(a), when the second intensity of the second laser beam L2 is relatively high, the second deformed portion 12 may be formed to a relatively large extent in the thickness direction of the glass substrate 1 and may be formed to a relatively small extent in the horizontal direction of the glass substrate 1.

Since the second deformed portion 12 is etched at a relatively high rate in the thickness direction of the glass substrate 1, the enlarged inner diameter portion 22a may have a relatively large inclination angle θ1.

Referring to FIG. 8(b), when the second intensity of the second laser beam L2 is relatively low, the second deformed portion 12 may be formed to a relatively small extent in the thickness direction of the glass substrate 1 and may be formed to a relatively large extent in the horizontal direction of the glass substrate 1.

Since the second deformed portion 12 is etched at a relatively low rate in the thickness direction of the glass substrate 1, the enlarged inner diameter portion 22a may have a relatively small inclination angle θ2.

As such, through adjustment of the difference between the second radius R2 of the second imaginary line and the first radius R1 of the first imaginary line, the second intensity of the second laser beam L2, and the like, the shape of the enlarged inner diameter portion 22 can be variously adjusted.

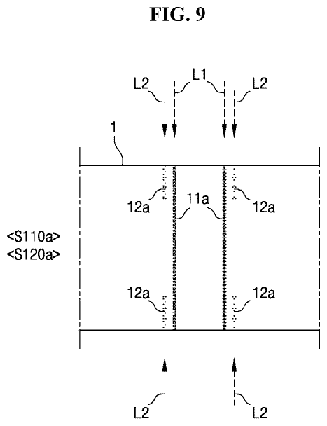

FIG. 9 is a view illustrating a first modification of the first deformed portion formation step and the second deformed portion formation step.

Referring to FIG. 9, to ensure that a region A1 of the glass substrate 1 where the first deformed portion 11 is etched away has a relatively high etch selectivity (a first etch selectivity), in a first deformed portion formation step S110a, the first laser beam L1 may be applied to the glass substrate 1 such that a first deformed portion 11a is formed throughout the thickness of the glass substrate 1.

Conversely, to ensure that a region A2 of the glass substrate 1 where the second deformed portion 12 is etched away has a second etch selectivity lower than the first etch selectivity, in a second deformed portion formation step S120a, the second laser beam L2 may be applied to the glass substrate 1 such that a second deformed portion 12a is formed in some regions of an upper portion and a lower portion of the glass substrate 1.

Subsequently, through the via-hole formation step S130, a via-hole 2 having an enlarged inner diameter portion at both ends thereof adjoining the upper and lower surfaces of the glass substrate 1 may be formed.

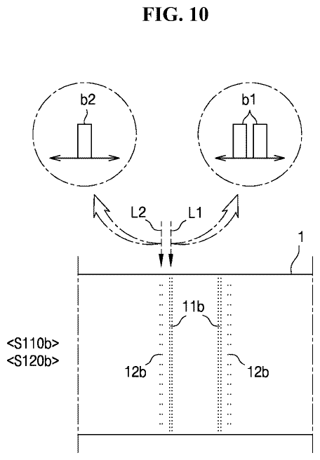

FIG. 10 is a view illustrating a second modification of the first deformed portion formation step and the second deformed portion formation step.

Referring to FIG. 10, to ensure that a region A1 of the glass substrate 1 where the first deformed portion 11 is etched away has a relatively high etch selectivity (a first etch selectivity), in a first deformed portion formation step S110b, the first laser beam L1 may be applied to the glass substrate 1 in the form of a first number of bursts b1 in burst mode to form a first deformed portion 11b.

Conversely, to ensure that a region A2 of the glass substrate 1 where the second deformed portion 12 is etched away has a second etch selectivity lower than the first etch selectivity, in a second deformed portion formation step S120b, the second laser beam L2 may be applied to the glass substrate 1 in the form of a second number of bursts b2 fewer than the first number of bursts in burst mode to form a second deformed portion 12b.

Although the first laser beam L1 is shown as being emitted as two bursts b1 and the second laser beam L2 is shown as being emitted as one burst b2 in FIG. 10, it should be understood that the numbers of bursts of the first laser beam and the second laser beam are not limited to specific values, so long as the second number is less than the first number.

Subsequently, through the via-hole formation step S130, a via-hole 2 having an enlarged inner diameter portion at both ends thereof adjoining the upper and lower surfaces of the glass substrate 1 may be formed.

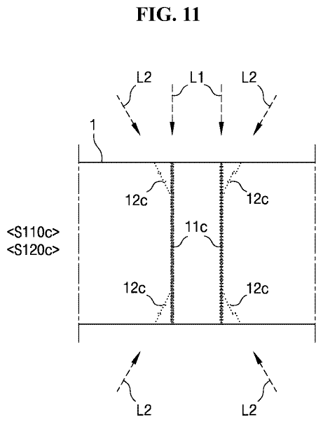

FIG. 11 is an exemplary view of a first deformed portion formation step and a second deformed portion formation step according to another embodiment of the present invention.

Referring to FIG. 11, in a first deformed portion formation step S110c, a first deformed portion 11c may be formed by applying the first laser beam L1 perpendicularly to the upper and lower surfaces of the glass substrate 1. In addition, in a second deformed portion formation step S120c, a second deformed portion 12c may be formed by applying the second laser beam L2 obliquely to the upper and lower surfaces of the glass substrate 1.

Subsequently, through the via-hole formation step S130, a via-hole 2 having an enlarged inner diameter portion 22 at both ends thereof adjoining the upper and lower surfaces of the glass substrate 1 may be formed.

As the first deformed portion 11c formed by the first laser beam L1 applied perpendicularly to the glass substrate is etched, a uniform inner diameter portion 21 of the via-hole 2 is formed. Concurrently, as the second deformed portion 12c formed by the second laser beam L2 applied obliquely to the glass substrate is etched, an enlarged inner diameter portion 22 of the via-hole 2 is formed. As a result, the via-hole 2 having the enlarged inner diameter portion 22 is formed through the glass substrate 1.

Although the method according to the present invention is presented in a series of numbered steps for clarity, it should be understood that this numbering doesn't dictate their sequence. Some of these steps may be skipped, performed in parallel, or performed in any order. In general, though, the steps of the method proceed in the numerical order specified herein.

Although some embodiments have been described herein, it should be understood by those skilled in the art that various modifications, changes, alterations, and equivalent embodiments can be made without departing from the spirit and scope of the invention. Therefore, the embodiments described above are to be considered in all respects as illustrative and not restrictive. For example, components described as implemented separately may also be implemented in combined form, and vice versa.

The scope of the present invention is indicated by the following claims and all changes or modifications derived from the meaning and scope of the claims and equivalents thereto should be construed as being within the scope of the present invention.

1. A glass substrate processing method comprising:
a first deformed portion formation step in which a first deformed portion is formed in a glass substrate by moving a first laser beam along a first imaginary line having a first radius;
a second deformed portion formation step in which a second deformed portion is formed in the glass substrate by moving a second laser beam along a second imaginary line having a second radius larger than the first radius; and
a via-hole formation step in which a via-hole having an enlarged inner diameter portion at both ends thereof adjoining upper and lower surfaces of the glass substrate is formed by dipping the glass substrate with the first deformed portion and the second deformed portion formed therein in an etching solution such that the first deformed portion and the second deformed portion are etched,
wherein a region of the glass substrate in which the first deformed portion is etched away has a first etch selectivity and a region of the glass substrate in which the second deformed portion is etched away has a second etch selectivity lower than the first etch selectivity.

2. The glass substrate processing method according to claim 1, wherein
in the first deformed portion formation step, the first laser beam is applied to the glass substrate with a first intensity, and,
in the second deformed portion formation step, the second laser beam is applied to the glass substrate with a second intensity lower than the first intensity.

3. The glass substrate processing method according to claim 1, wherein
in the first deformed portion formation step, the first laser beam is applied to the glass substrate such that the first deformed portion is formed throughout a thickness of the glass substrate, and,
in the second deformed portion formation step, the second laser beam is applied to the glass substrate such that the second deformed portion is formed in a region of an upper portion of the glass substrate and in a region of a lower portion of the glass substrate.

4. The glass substrate processing method according to claim 1, wherein
in the first deformed portion formation step, the first laser beam is applied to the glass substrate in the form of a first number of bursts, and,
in the second deformed portion formation step, the second laser beam is applied to the glass substrate in the form of a second number of bursts fewer than the first number of bursts.

5. The glass substrate processing method according to claim 1, wherein, in the via-hole formation step, the via-hole is formed by removing the first deformed portion, the second deformed portion, and a region of the glass substrate located inside the first imaginary line.

6. The glass substrate processing method according to claim 1, wherein the second radius of the second imaginary line is less than or equal to a target radius of the via-hole.

7. The glass substrate processing method according to claim 1, wherein
the enlarged inner diameter portion has a horizontal length, and
the horizontal length of the enlarged inner diameter portion increases with increasing difference between the second radius of the second imaginary line and the first radius of the first imaginary line.

8. The glass substrate processing method according to claim 1, wherein
the enlarged inner diameter portion has an inclination angle,
the second laser beam is applied to the glass substrate with a second intensity, and
the inclination angle of the enlarged inner diameter portion decreases with decreasing second intensity of the second laser beam.

9. A glass substrate processing method comprising:
a first deformed portion formation step in which a first deformed portion is formed in a glass substrate by moving a first laser beam along a first imaginary line having a first radius;
a second deformed portion formation step in which a second deformed portion is formed in the glass substrate by moving a second laser beam along a second imaginary line having a second radius larger than the first radius; and
a via-hole formation step in which a via-hole having an enlarged inner diameter portion at both ends thereof adjoining upper and lower surfaces of the glass substrate is formed by dipping the glass substrate with the first deformed portion and the second deformed portion formed therein in an etching solution such that the first deformed portion and the second deformed portion are etched,
wherein the first laser beam is applied perpendicularly to upper and lower surfaces of the glass substrate and the second laser beam is applied obliquely to the upper and lower surfaces of the glass substrate.

10. The glass substrate processing method according to claim 9, wherein, in the via-hole formation step, the via-hole is formed by removing the first deformed portion, the second deformed portion, and a region of the glass substrate located inside the first imaginary line.
